(19) United States
(12) Patent Application Publication
(10) Pub. No.: US 2011/0058024 A1
(43) Pub. Date: Mar. 10, 2011

(54) DISPLAY APPARATUS AND METHOD OF DRIVING THE SAME

(75) Inventors: Hee-Jin CHOI, Seoul (KR); Junpyo LEE, Asan-si (KR); Jung-Won KIM, Seoul (KR); Sunkyu SON, Suwon-si (KR); Jae-Ho OH, Seoul (KR); Yong-Bum KIM, Yongin-si (KR); Ok-Kwon SHIN, Asan-si (KR); Nam-Gon CHOI, Asan-si (KR); Seonki KIM, Anyang-si (KR)

(73) Assignee: SAMSUNG ELECTRONICS CO., LTD., Suwon-si (KR)

(21) Appl. No.: 12/877,376

(22) Filed: Sep. 8, 2010

(30) Foreign Application Priority Data
Sep. 9, 2009 (KR) 10-2009-0085064
Apr. 29, 2010 (KR) 10-2010-0040236

(51) Int. Cl. H04N 13/04

(52) U.S. Cl. 348/51; 348/E13.053

(57) ABSTRACT

In a display apparatus, a display panel displays an image, and a frame rate converter separates an image signal to a first image frame for a left-eye and a second image frame for a right-eye and generates first and second intermediate image frames respectively following the first and second image frames. A timing controller converts the first and second image frames to first and second compensation frames, respectively, and sequentially provides the first compensation frame, the first intermediate image frame, the second compensation frame, and the second intermediate image frame to a data driver. The data driver converts the first and second compensation frames to a left-eye data voltage and a right-eye data voltage, respectively, and converts the first and second intermediate image frames to a predetermined black data voltage.

This application claims priority to Korean Patent Applications No. 2009-85064, filed on Sep. 9, 2009 and No. 2010-40236, field on Apr. 29, 2010, and all the benefits accruing therefrom under 35 U.S.C. §119, the contents of which in their entireties are herein incorporated by references.

### BACKGROUND

1. Field of Disclosure

The present invention relates to a display apparatus and a method of driving the same. More particularly, the present invention relates to a display apparatus capable of improving its display quality and reducing the number of parts thereof and a method of driving the display apparatus.

2. Description of the Related Art

In general, a 3-dimensional (also referred to as “3-D”) image display apparatus alternately displays a left-eye image corresponding to a left eye of a viewer and a right-eye image corresponding to a right eye of a viewer on a single display panel in order to display a 3-dimensional image. In a conventional display, when the image displayed on the display panel is changed from the left-eye image to the right-eye image or vice versa, the left-eye image and the right-eye image are mixed with each other due to a scanning method of the display panel, e.g., portions of the left-eye image and the right-eye image may be simultaneously displayed on the display panel, thereby causing deterioration in display quality.

In addition, in order to increase of a response speed of liquid crystal molecules, the conventional 3-dimensional image display apparatus employs a driving method that corrects a present image, i.e., a currently displayed image, using a correction voltage in consideration of a target voltage of the present image and a driving voltage of a previous image. For example, if a target gray scale of a particular pixel corresponds to a voltage of 5 V, but the previous frame included a gray scale of 0 V at that particular pixel, a correction voltage having a larger voltage difference, e.g., 6 V, may be applied to the particular pixel in order to ensure that the gray scale corresponding to the target voltage is reached. Thus, the 3-dimensional image display apparatus requires memories to store the driving voltage of the previous image among the left-eye image and the right-eye image. The use of multiple memory units undesirably adds to the manufacturing costs of 3-dimensional image displays.

### SUMMARY

Exemplary embodiments of the present invention provide a display apparatus with improved display quality and reduced parts.

Exemplary embodiments of the present invention also provide a method of driving the display apparatus.

According to exemplary embodiments of the present invention, a display apparatus includes a display panel that displays an image, a frame rate converter, a timing controller, and a data driver.

The frame rate converter separates an image signal from an exterior to a first image frame for a left-eye and a second image frame for a right-eye and generates a first intermediate image frame following the first image frame and a second intermediate image frame following the second image frame to convert the image signal to a four-times-faster image signal. The timing controller compensates for the first and second image frames to generate first and second compensation frames, respectively, and sequentially outputs the first compensation frame, the first intermediate image frame, the second compensation frame, and the second intermediate image frame. The data driver converts the first and second compensation frames from the timing controller to a left-eye data voltage and a right-eye data voltage, respectively, and converts the first and second intermediate image frames to a black data voltage corresponding to a predetermined black gray scale in response to a black insertion control signal to provide the black data voltage to the display panel.

According to exemplary embodiments of the present invention, a method of driving a display apparatus is provided as follows. The display apparatus separates an image signal to a first image frame for a left-eye and a second image frame for a right-eye and generates a first intermediate image frame following the first image frame and a second intermediate image frame following the second image frame. Then, the display apparatus compensates for the first and second image frames to generate a first compensation frame and a second compensation frame, converts the first and second compensation frames to a left-eye data voltage and a right-eye data voltage, respectively, and converts the first and second intermediate image frames to a black data voltage corresponding to a predetermined black gray scale in response to a black insertion control signal. The display apparatus displays an image in order of the left-eye data voltage, the black data voltage, the right-eye data voltage, and the black data voltage.

According to exemplary embodiments of the present invention, a method of driving a display apparatus is provided as follows. The display apparatus separates an image signal to a first image frame for a left-eye and a second image frame for a right-eye and generates a first intermediate image frame following the first image frame and a second intermediate image frame following the second image frame. Then, the display apparatus converts the first image frame to a left-eye data voltage and the second image frame to a right-eye data voltage and inserts a black data voltage corresponding to a predetermined black gray scale between the left-eye data voltage and the right-eye data voltage in response to a black insertion control signal. The display apparatus consecutively receives the left-eye data voltage, the black data voltage, and the right-eye data voltage to display an image.

According to the above, when a 3-dimensional image is displayed, the intermediate image frames respectively following the left-eye and right-eye image frames are generated and the intermediate image frames are converted to the black data voltage by the data driver, thereby preventing left-eye images from being mixed with right-eye images. In addition, the number of the frame memories required for a dynamic capacitance compensation method may be reduced, to thereby reduce manufacturing cost of the display apparatus.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing a display apparatus according to an exemplary embodiment of the present invention;

FIG. 2 is a block diagram showing a frame rate converter of FIG. 1;

FIG. 3 is a block diagram showing a timing controller of FIG. 1;

FIG. 4 is a block diagram showing a data driver of FIG. 1;

FIG. 5 is a view showing a resistor string included in a digital-to-analog converter of FIG. 4;

FIG. 6 is a circuit diagram showing a black data selector of FIG. 4;

FIG. 7 is a block diagram showing a data driver according to another exemplary embodiment of the present invention;

FIG. 8 is a waveform diagram illustrating a driving operation of a display apparatus with reference to FIGS. 1 and 7;

FIG. 9 is a block diagram showing a display apparatus according to another exemplary embodiment of the present invention; and

FIG. 10 is a flow chart illustrating a method of displaying a 3-dimensional image on a display apparatus of FIG. 1.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

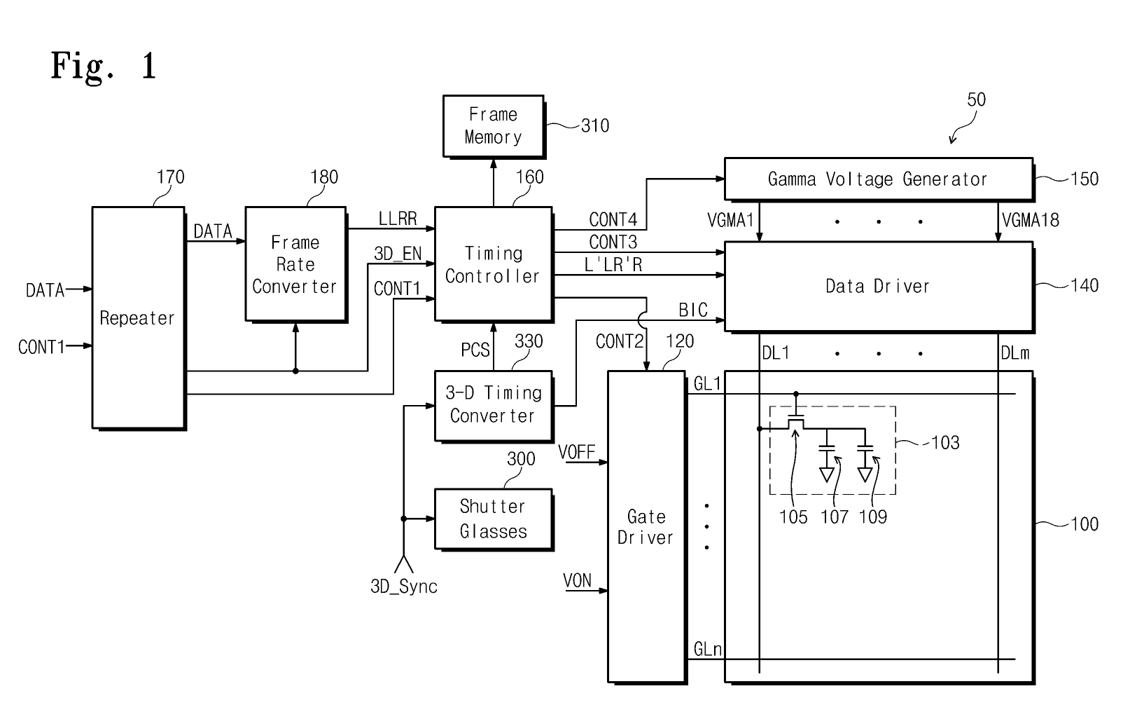

FIG. 1 is a block diagram showing a display apparatus according to an exemplary embodiment of the present invention.

Referring to FIG. 1, a display apparatus 50 includes a display panel 100 displaying an image, a gate driver 120 driving the display panel 100 together with a data driver 140, a gamma voltage generator 150 connected to the data driver 140, and a timing controller 160 controlling the gate driver 120 and the data driver 140. The display apparatus 50 may further include a repeater 170, a frame rate converter 180, a frame memory 310, a 3-dimensional (“3-D”) timing converter 330, and a shutter glasses 300.

The repeater 170 receives a 2-dimensional (“2-D”) image signal DATA from a video system (not shown). The repeater 170 may receive the 2-D image signal DATA through a low voltage differential signaling (LVDS). The repeater 170 provides the 2-D image signal DATA to the frame rate converter 180.

The frame rate converter 180 receives the 2-D image signal DATA from the repeater 170, converts the 2-D image signal DATA to a 3-D image signal and converts the frame rate of the 3-D image signal to correspond to the frame rate of the display panel 100. For instance, the frame rate converter 180 separates the 2-D image signal DATA having a frequency of about 60 Hz into an image frame for a left-eye (hereinafter, referred to as “left-eye image frame L”) and an image frame for a right-eye (hereinafter, referred to as “right-eye image frame R”) to generate the 3-D image signal, and then the frame rate converter 180 may convert the 3-D image signal to a four-times-faster image signal LLRR having a frequency of about 240 Hz. In this case, the frame rate converter 180 may have a driving frequency of about 240 Hz, but it should not be limited thereto or thereby. That is, the frame rate converter 180 may have a frequency of about 120 Hz or about 360 Hz.

The 2-D image signal DATA having the frequency of about 60 Hz includes a plurality of frames and each frame may be output during 1/60 second. Meanwhile, the four-times-faster image signal LLRR includes a plurality of frames and each frame may be output during 1/240 second.

In order to output the four-times-faster image signal LLRR, the frame rate converter 180 separates the image signal from the repeater 170 into the left-eye image frame L and the right-eye image frame R to generate a two-times-faster image signal. Then, the frame rate converter 180 generates a first intermediate image frame L following the left-eye image frame L and a second intermediate image frame R following the right-eye image frame R. The first intermediate image frame L may have the same value as the left-eye image frame L and the second intermediate image frame R may have the same value as the right-eye image frame R. Thus, the frame rate converter 180 may convert the two-times-faster image signal to the four-times-faster image signal LLRR.

In addition, one frame rate converter 180 has been shown in FIG. 1, but the display apparatus 50 may include two frame rate converts. As described above, in case that the display apparatus 50 includes two frame rate converters, a first frame rate converter receives the image signal DATA from the repeater 170 and generates a left-side image signal corresponding to a left-side region of the display panel 100 with reference to an imaginary line passing through a center of the display panel 100. Similarly, a second frame rate convert receives the image signal DATA from the repeater 170 and generates a right-side image signal corresponding to a right-side region of the display panel 100 with reference to the imaginary line passing through the center of the display panel 100.

The timing controller 160 receives the four-times-faster image signal LLRR from the frame rate converter 180 and a control signal CONT1 from the repeater 170. The timing controller 160 compensates for the four-times-faster image signal LLRR by using a data compensation method compensating for charge rate of each pixel and outputs a four-times-faster compensation image signal L′LR′R. In detail, the timing controller 160 compensates for the left-eye image frame L to generate a left-eye compensation frame L′ and compensates for the right-eye image frame R to generate a right-eye compensation frame R′. In addition, the timing controller 160 outputs the first and second intermediate image frames L and R without applying the data compensation method to the first and second intermediate image frames L and R.

The control signal CONT1 provided to the timing controller 160 may include a main clock signal MCLK, a vertical synchronization signal VSYNC, a horizontal synchronization signal HSYNC, a data enable signal DE. The timing controller 160 generates a gate control signal CONT2 to control an operation of the gate driver 120 and a data control signal CONT3 to control an operation of the data driver 140 in response to the control signal CONT1 and applies the gate control signal CONT2 and the data control signal CONT3 to the gate driver 120 and the data driver 140, respectively.

The timing controller 160 receives a 3-D enable signal 3D_EN and generates a gamma selection control signal CONT4 in response to the 3-D enable signal 3D_EN. The gamma selection control signal CONT4 is applied to the gamma voltage generator 150. The gamma voltage generator 150 outputs gamma reference voltages VGMA1 to VGMA18 for a 3-dimensional image in response to the gamma selection control signal CONT4 having a high level. Although not shown in FIG. 1, when a 2-D enable signal 2D_EN is applied to the timing controller 160, the gamma voltage generator 150 may output gamma reference voltages for a 2-dimensional image, which have a different voltage level from the 3-D gamma reference voltages VGMA1 to VGMA18, in response to the gamma selection control signal CONT4 having a low level. The display panel 100 includes a plurality of gate lines GL1 to GLn each receiving a gate voltage and a plurality of data lines DL1 to DLm each receiving a data voltage. In addition, the display panel 100 includes a plurality of pixel areas arranged in a matrix configuration and plural pixels are arranged in the pixel areas in a one-to-one correspondence. Since the pixels have the same structure and function, for the convenience of explanation, one pixel 103 will be described as a representative example. The pixel 103 includes a thin film transistor 105, a liquid crystal capacitor 107, and a storage capacitor 109.

The thin film transistor 105 includes a gate electrode connected to a first gate line GL1, a source electrode connected to a first data line DL1, and a drain electrode connected to the liquid crystal capacitor 107 and the storage capacitor 109. The liquid crystal capacitor 107 and the storage capacitor 109 are connected to the drain electrode in parallel.

Although not shown in FIG. 1, the display panel 100 may include a first display substrate (not shown), a second display substrate (not shown) facing the first display substrate, and a liquid crystal layer (not shown) interposed between the first and second display substrates.

The gate lines GL1 to GLn, the data lines DL1 to DLm, the thin film transistor 105, and a pixel electrode (not shown) serving as a first electrode of the liquid crystal capacitor 107 are disposed on the first substrate. The thin film transistor 105 applies the data voltage to the pixel electrode in response to the gate voltage.

Meanwhile, a common electrode (not shown) serving as a second electrode of the liquid crystal capacitor 107 is disposed on the second display substrate and a reference voltage is applied to the common electrode. The liquid crystal layer disposed between the pixel electrode and the common electrode serves as a dielectric substance. The liquid crystal capacitor 107 is charged with a voltage corresponding to an electric potential difference between the data voltage and the reference voltage.

The gate driver 120 is electrically connected to the gate lines GL1 to GLn in the display panel 100 to apply the gate voltage to the gate lines GL1 to GLn. Particularly, the gate driver 120 generates gate signals including a gate on voltage VON and a gate off voltage VOFF based on the gate control signal CONT2 from the timing controller 160 in order to drive the gate lines GL1 to GLn and sequentially outputs the gate signals to the gate lines GL1 to GLn. The gate control signal CONT2 may include a vertical start signal STV that starts a driving of the gate driver 120, a gate clock signal GCLK that determines an output timing of the gate voltage, and an output enable signal OE that determines a pulse width of the gate on voltage.

The data driver 140 receives the four-times-faster compensation image signal L′LR′R from the timing controller 260 and respectively converts the left-eye compensation frame L′ and the right-eye compensation frame R′ to a left-eye data voltage and a right-eye data voltage in response to the data control signal CONT3 to apply the left-eye data voltage and the right-eye data voltage to the display panel 100. Specifically, the data driver 140 may convert the left-eye compensation frame L′ and the right-eye compensation frame R′ to the left-eye data voltage and the right-eye data voltage, respectively, in response to the 3-D gamma reference voltages VGMA1 to VGMA18. The data control signal CONT3 may include a horizontal start signal STH starting a drive of the data driver 140, an inversion signal POL controlling a polarity of the left-eye data voltage and the right-eye data voltage, and a load signal TP determining an output timing of the left-eye data voltage and the right-eye data voltage.

Responsive to a black insertion control signal BIC provided from the 3-D timing converter 330, the data driver 140 converts the first and second intermediate image frames L and R of the four-times-faster compensation image signal L′RR′R to a black data voltage and applies the black data voltage to the display panel 100.

The data driver 140 is electrically connected to the data lines DL1 to DLm in the display panel 100 and applies the left-eye data voltage, the black data voltage, and the right-eye data voltage to the data lines DL1 to DLm in order of the left-eye data voltage, the black data voltage, the right-eye data voltage, and the black data voltage.

The display apparatus 50 may further include the frame memory 310 connected to the timing controller 160 to store a previous image frame and the 3-D timing converter 330 to apply the black insertion control signal BIC to the data driver 140.

The frame memory 310 sequentially stores the frames of the four-times-faster image signal LLRR provided to the timing controller 160. For instance, when the left-eye image frame R is provided to the timing controller 160, the frame memory 310 stores the first intermediate image frame L as the previous frame and provides the first intermediate image frame L to the timing controller 160 in response to the request of the timing controller 160. The timing controller 160 may convert the right-eye image frame R to the right-eye compensation frame R′ based on the data of the first intermediate image frame L.

The 3-D timing converter 330 receives a 3-D synchronization signal 3D_sync from the video system and provides the black insertion control signal BIC to the data driver 140 in response to the 3-D synchronization signal 3D_sync. In addition, the 3-D timing converter 330 provides an inversion control signal PCS to the timing controller 160. The timing controller 160 changes an inversion period of the inversion signal POL, which controls the polarity of the left-eye data voltage and the right-eye data voltage, in response to the inversion control signal PCS and the timing controller 160 provides the changed inversion signal POL to the data driver 140. For example, when a 2-D synchronization signal occurs, the timing controller 160 changes the inversion period of the inversion signal POL to have a length corresponding to one frame, and when the 3-D synchronization signal 3D_sync occurs, the timing controller 160 changes the inversion period of the inversion signal POL to have a length corresponding to two frames.

The display apparatus 50 may further include the shutter glasses 300 to observe the image displayed through the display panel 100.

The shutter glasses 300 include a left-eye shutter (not shown) and a right-eye shutter (not shown). The shutter glasses 300 receive the 3-D synchronization signal 3D_sync and sequentially drive the left-eye shutter and the right-eye shutter in response to the 3-D synchronization signal 3D_sync. When a user wears the shutter glasses 300, the user may watch the 3-D image on the display panel 100 through the left-eye shutter and the right-eye shutter.

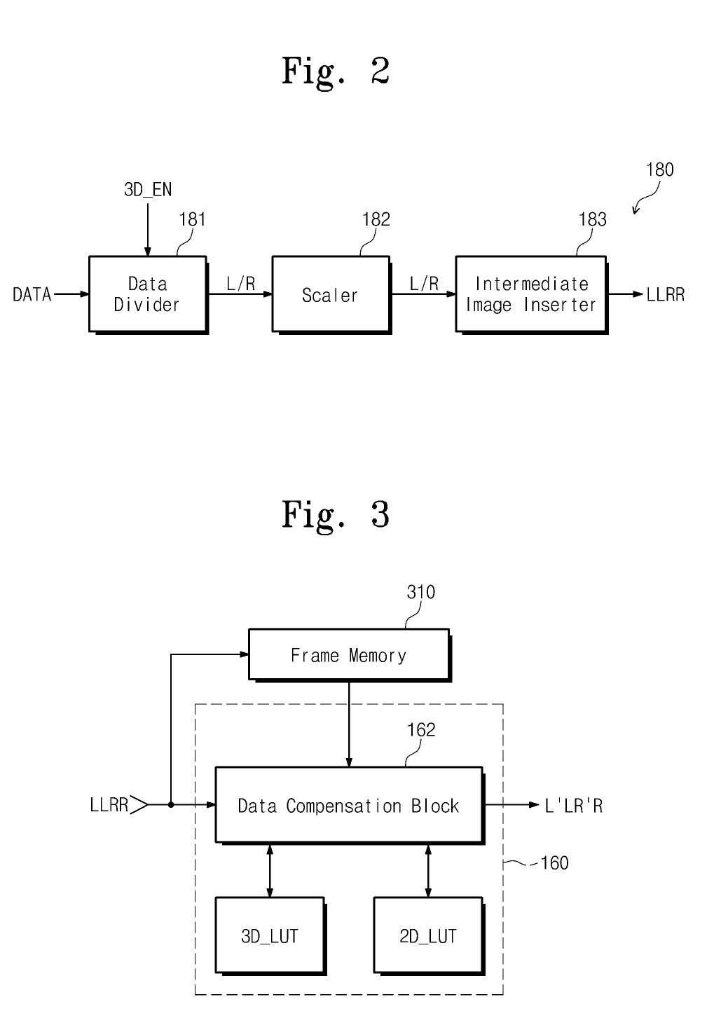

FIG. 2 is a block diagram showing the frame rate converter 180 of FIG. 1.

Referring to FIG. 2, the frame rate converter 180 may include a data divider 181, a scaler 182, and an intermediate image inserter 183.

The data divider 181 receives the 2-D image signal DATA from the repeater 170 and separates the 2-D image signal DATA into the left-eye image frame L and the right-eye image frame R in response to the 3-D enable signal 3D_EN to output the two-times-faster image signal LR. The data divider 181 provides the left-eye image frame L and the right-eye image frame R to the scaler 182.

The scaler 182 receives the left-eye image frame L and the right-eye image frame R from the data divider 181. The scaler 182 converts the format of the left-eye and right-eye image frames L and R to allow the left-eye and right-eye image frames L and R to have a resolution corresponding to a resolution of the display panel 100.

The intermediate image inserter 183 inserts the first intermediate image frame L having the same value as an N-th left-eye image frame L between the N-th left-eye image frame L and an N-th right-eye image frame R, which are provided from the scaler 182. In addition, the intermediate image inserter 183 inserts the second intermediate image frame R having the same value as the N-th right-eye image frame R between the N-th right-eye image frame and a (N+1)-th left-eye image frame L.

Accordingly, the intermediate image inserter 183 sequentially outputs the N-th left-eye image frame L, the first intermediate image frame L, the N-th right-eye image frame R, and the second intermediate image frame R, so the two-times-faster image signal LR may be converted to the four-times-faster image signal LLRR.

Although not shown in FIGS. 1 and 2, in case that the frame rate converter 180 receives the 2-D image signal at 60 Hz, the frame rate converter 180 may changes the frame rate of the 2-D image signal without separating the 2-D image signal to the left-eye image frame and the right-eye image frame. In other words, the frame rate converter 180 may convert the 2-D image signal at 60 Hz to four-times-faster 2-D image signal at 240 Hz.

FIG. 3 is a block diagram showing the timing controller 160 of FIG. 1.

Referring to FIG. 3, the timing controller 160 includes a data compensation block 162, a first look-up table 3D_LUT, and a second look-up table 2D_LUT. The first look-up table 3D_LUT stores 3D compensation values and the second look-up table 2D_LUT stores 2D compensation values. Thus, the data compensation block 162 references the first look-up table 3D_LUT in the 3-D mode and references the second look-up table 2D_LUT in the 2-D mode.

As shown in FIG. 3, when the four-times-faster image signal LLRR is applied to the data compensation block 162, the data compensation block 162 compensates for the four-times-faster image signal LLRR to the four-times-faster compensation image signal L′LR′R with reference to the first look-up table 3D_LUT.

The frame memory 310 sequentially stores the four-times-faster image signal LLRR. For instance, when the left-eye image frame L is applied to the data compensation block 162, the second intermediate image frame R of a previous frame is previously stored in the frame memory 310 and the second intermediate image frame R of the previous frame is provided to the data compensation block 162 according to the request from the data compensation block 162. The data compensation block 162 may convert the left-eye image frame L to the left-eye compensation image frame L′ based on the data of the second intermediate image frame R of the previous frame.

In addition, when the right-eye image frame R is applied to the data compensation block 162, the first intermediate image frame L of the previous frame is previously stored in the frame memory 310 and the first intermediate image frame L of the previous frame is provided to the data compensation block 162 according to the request from the data compensation block 162. The data compensation block 162 may convert the right-eye image frame R to the right-eye compensation frame R′ based on the data of the first intermediate image frame L of the previous frame.

When the first and second intermediate image frames L and R are provided to the data compensation block 162, the data compensation block 162 outputs the first and second intermediate image frames L and R without compensating for the data of each of the first and second intermediate image frames L and R. Since the first and second intermediate image frames L and R are substantially not provided to the display panel, the data of the first and second intermediate image frames L and R are needed to be compensated. Thus, the timing controller 160 may output the four-times-faster compensation image signal L′LR′R in order of the left-eye compensation frame L′, the first intermediate image frame L, the right-eye compensation frame R′, and the second intermediate image frame R.

As described above, the first intermediate image frame L has the same value as the left-eye image frame L and the second intermediate image frame R has the same value as the right-eye image frame R. Accordingly, the data compensation block 162 may reference the first intermediate image frame L, which is the previous frame, to compensate for the right-eye image frame R. In addition, the data compensation block 162 may reference the second intermediate image frame R, which is the previous frame, to compensate for the left-eye image frame L.

In case that the first intermediate image frame L has the same value as the left-eye image frame L and the second intermediate image frame R has the same value as the right-eye image frame R, the frame memory 310 is enough to store the data corresponding to one frame in order to compensate for the data. However, since the frame memory 310 is needed to store the data corresponding to two frames in order to compensate for the left-eye and right-eye image frames L and R when the first intermediate image frame L has a value different from the left-eye image frame L and the second intermediate image frame R has a value different from the right-eye image frame R, the number of the frame memories may be increased. Accordingly, as described above, when the first intermediate image frame L has the same value as the left-eye image frame L and the second intermediate image frame R has the same value as the right-eye image frame R, the number of the frame memories that is needed to compensate for the four-times-faster image signal LLRR may be prevented from increasing.

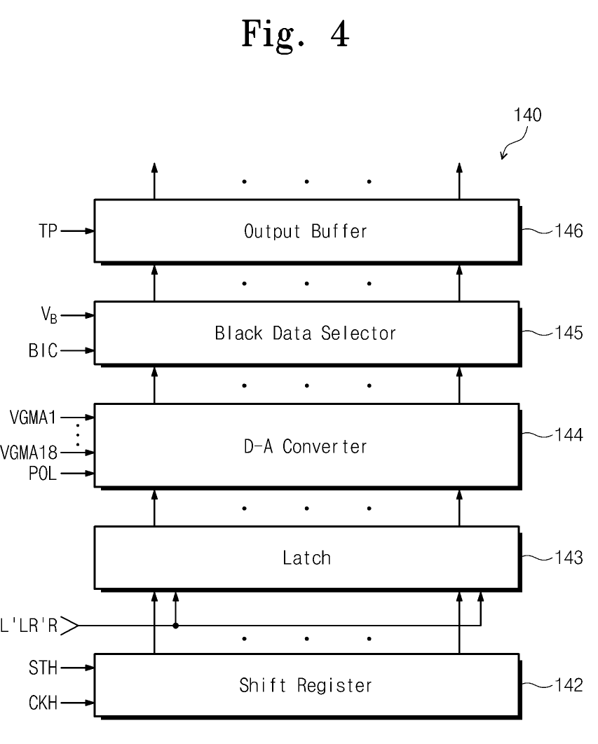

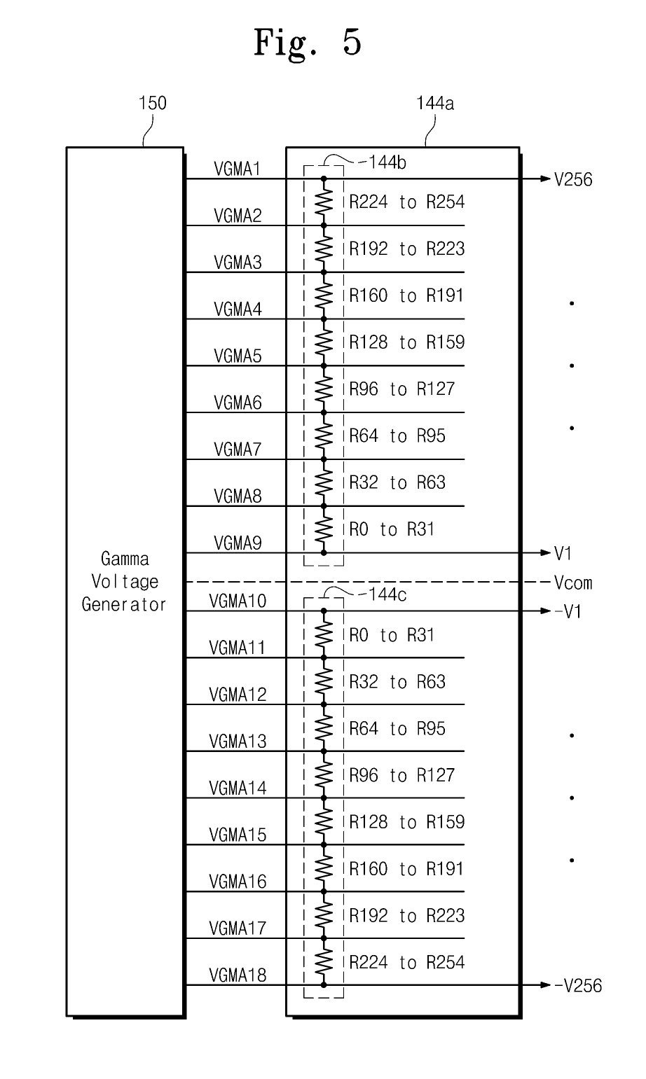

FIG. 4 is a block diagram showing the data driver 140 of FIG. 1 and FIG. 5 is a view showing a resistor string included in a digital-to-analog converter of FIG. 4.

Referring to FIG. 4, the data driver 140 includes a shift register 142, a latch 143, a digital-to-analog (D-A) converter 144, a black data selector 145, and an output buffer 146.

The shift register 142 includes a plurality of stages (not shown) connected to each other one after another, each stage receives a horizontal clock signal CKH, and a first stage among the stages receives the horizontal start signal STH. When the first stage starts its operation in response to the horizontal start signal STH, the stages sequentially output control signal in response to the horizontal clock signal CKH.

The latch 143 receives the four-times-faster compensation image signal L′LR′R from the timing controller and sequentially latches the data corresponding to one line of the four-times-faster compensation image signal L′LR′R in response to the control signals sequentially provided from the stages. The latch 143 provides the latched data corresponding to one line to the D-A converter 144.

The D-A converter 144 receives the data from the latch 143 and converts the data to the data voltage based on the gamma reference voltages VGMA1 to VGMA18.

Referring to FIG. 5, the D-A converter 144 may include a resistor string 144a to convert the eighteen gamma reference voltages VGMA1 to VGMA18 to 2×2^{k} gray scale voltages. In the present exemplary embodiment, the “k” may be the bit number of the data. That is, when the data is 8-bit data, the resistor string 144a may convert the gamma reference voltages VGMA1 to VGMA18 to 512 gray scale voltages.

In addition, the resistor string 144a includes a positive-polarity resistor string 144b and a negative-polarity resistor string 144c to the gray scale voltages. The positive-polarity resistor string 144b may generate 256 positive-polarity gray scale voltages V1 to V256 based on a first gamma reference voltage to a ninth gamma reference voltage VGMA1 to VGMA9 among the gamma reference voltages VGMA1 to VGMA18. On the contrary, the negative-polarity resistor string 144c may generate 256 negative-polarity gray scale voltages −V1 to −V256 based on a tenth gamma reference voltage to a eighteenth gamma reference voltage VGMA10 to VGMA18 among the gamma reference voltages VGMA1 to VGMA18. As an example, the size of the gamma reference voltages VGMA1 to VGMA18 may decrease in order of the first gamma reference voltage VGMA1 to the eighteenth gamma reference voltage VGMA18.

The positive-polarity gray scale voltages V1 to V256 have a positive polarity with reference to a predetermined reference voltage (hereinafter, referred to as common voltage Vcom) and the negative-polarity gray scale voltages −V1 to −V256 have a negative polarity with reference to the common voltage Vcom. As an example, the positive-polarity gray scale voltages V1 to V256 may have a gray scale that becomes higher, i.e., a white gray scale, as the positive-polarity gray scale voltages V1 to V256 are spaced apart from the common voltage Vcom and the negative-polarity gray scale voltages −V1 to −V256 may have a gray scale that becomes lower, i.e., a black gray scale, as the negative-polarity gray scale voltages −V1 to −V256 are spaced apart from the common voltage Vcom.

The D-A converter 144 selects either the positive-polarity resistor string 144b or the negative-polarity resistor string 144c based on the inversion signal POL, selects the gray scale voltage corresponding to the data among the 256 gray scale voltages output from the selected resistor string, and outputs the selected gray scale voltage as the data voltage. The data voltage output from the D-A converter 144 is provided to the black data selector 145.

The black data selector 145 provides the data voltage from the D-A converter 144 or a black data voltage V_{B} instead of the data voltage to the output buffer 146 in response to the black insertion control signal BIC. In the present exemplary embodiment, the black data voltage V_{B} may have a voltage corresponding to the common voltage Vcom.

The output buffer 145 includes a plurality of operational amplifiers (not shown) and temporarily stores the data voltage or the black data voltage V_{B}, which are output from the black data selector 145. Then, the output buffer 145 outputs the stored voltage in response to the load signal TP at once.

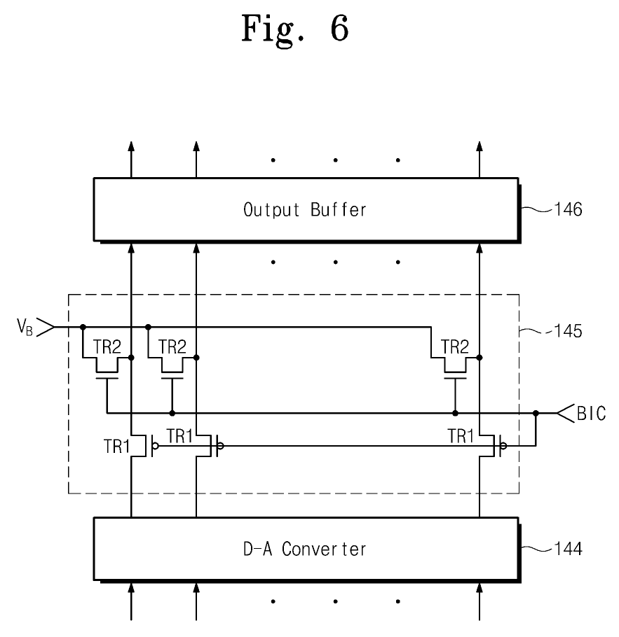

FIG. 6 is a circuit diagram showing the black data selector 145 of FIG. 4. Referring to FIG. 6, the black data selector 145 includes a plurality of first switching transistors TR1 that switches the data voltage in response to the black insertion control signal BIC and a plurality of second switching transistors TR2 that provides the black data voltage V_{B} instead of the data voltage to the output buffer 146 in response to the black insertion control signal BIC.

In detail, each of the first switching transistors TR1 includes a first electrode connected to a corresponding output terminal of the D-A converter 144, a second electrode receiving the black insertion control signal BIC, and a third electrode connected to a corresponding input terminal of the output buffer 146. As an example, each of the first switching transistors TR1 may be a p-type transistor.

Each of the second switching transistors TR2 includes a first electrode receiving the black data voltage V_{B}, a second electrode receiving the black insertion control signal BIC, and a third electrode connected to a corresponding input terminal of the output buffer 146. In the present exemplary embodiment, each of the second switching transistors TR2 may be an n-type transistor.

When the black insertion control signal BIC is in a logic low state, the first switching transistors TR1 are turned on and the second switching transistors TR2 are turned off. Accordingly, the data voltages output from the D-A converter 144 may be applied to the output buffer 146 through the black data selector 145. On the contrary, when the black insertion control signal BIC is in a logic high state, the first switching transistors TR1 are turned off and the second switching transistors TR2 are turned on. Thus, the data voltages output from the D-A converter 144 do not pass through the first switching transistors TR1. In addition, the black data voltage V_{B} passing through the second switching transistors TR2 may be applied to the input terminals of the output buffer 146.

Thus, the black data selector 145 outputs the black data voltage V_{B} in response to the black insertion control signal BIC for a period during which the first and second intermediate image frames L and R are provided without selecting the data voltage obtained by converting the first and second intermediate image frames L and R. In addition, responsive to the black insertion control signal BIC, the black data selector 145 outputs the data voltage converted from the left-eye compensation frame L′ for a period during which the left-eye compensation frame L′ is provided and outputs the data voltage converted from the right-eye compensation frame R′ for a period during which the right-eye compensation frame R′ is provided.

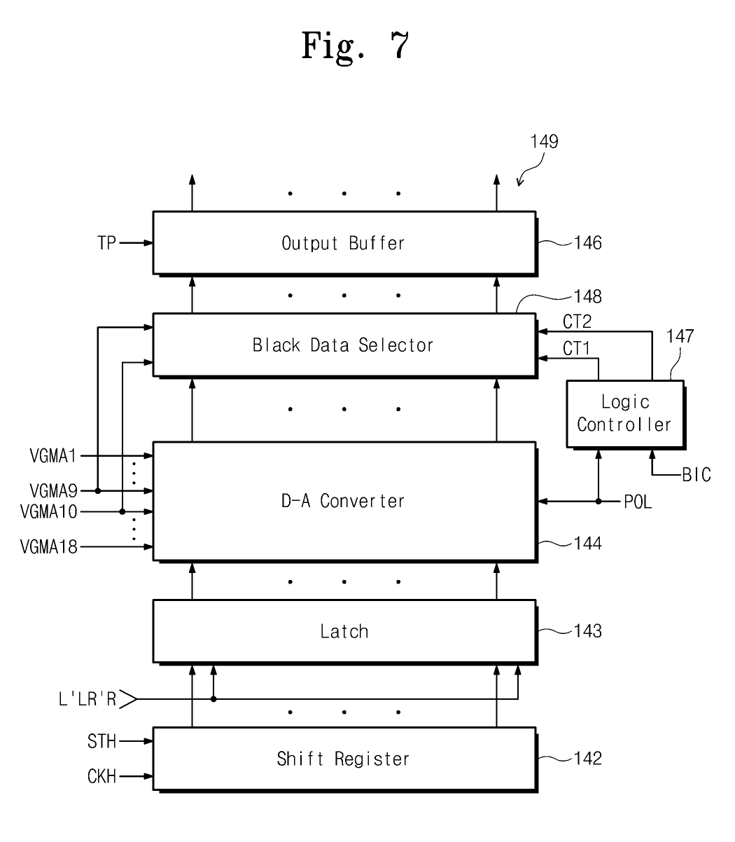

FIG. 7 is a block diagram showing a data driver according to another exemplary embodiment of the present invention. In FIG. 7, the same reference numerals denote the same elements in FIG. 4, and thus detailed descriptions of the same elements will be omitted.

Referring to FIG. 7, a data driver 149 includes a shift resistor 142, a latch 143, a D-A converter 144, a logic controller 147, a black data selector 148, and an output buffer 146.

The logic controller 147 generates a first control signal CT1 and a second control signal CT2 based on the inversion signal POL and the black insertion control signal BIC and provides the first and second control signals CT1 and CT2 to the black data selector 148.

The black data selector 148 receives the first and second control signals CT1 and CT2 and the ninth and tenth gamma reference voltages VGMA9 and VGMA10 among the gamma reference voltages VGMA1 to VGMA18 output from the gamma voltage generator 150. Accordingly, the black data selector 148 outputs either the ninth gamma reference voltage VGMA9 or the tenth gamma reference voltage VGMA10 as the black data voltage in response to the first and second control signals CT1 and CT2.

Particularly, when the first control signal CT1 is in a logic high state and the second control signal CT2 is in a logic low state, the black data selector 148 outputs the ninth gamma reference voltage VGMA9 as the positive-polarity black data voltage, which has the positive polarity with reference to the common voltage Vcom, is most approximate to the common voltage Vcom, and represents the black gray scale. Meanwhile, when the first control signal CT1 is in a logic low state and the second control signal CT2 is in a logic high state, the black data selector 148 outputs the tenth gamma reference voltage VGMA10 as the negative-polarity black data voltage, which has the negative polarity with reference to the common voltage Vcom, is most approximate to the common voltage Vcom, and represents the black gray scale.

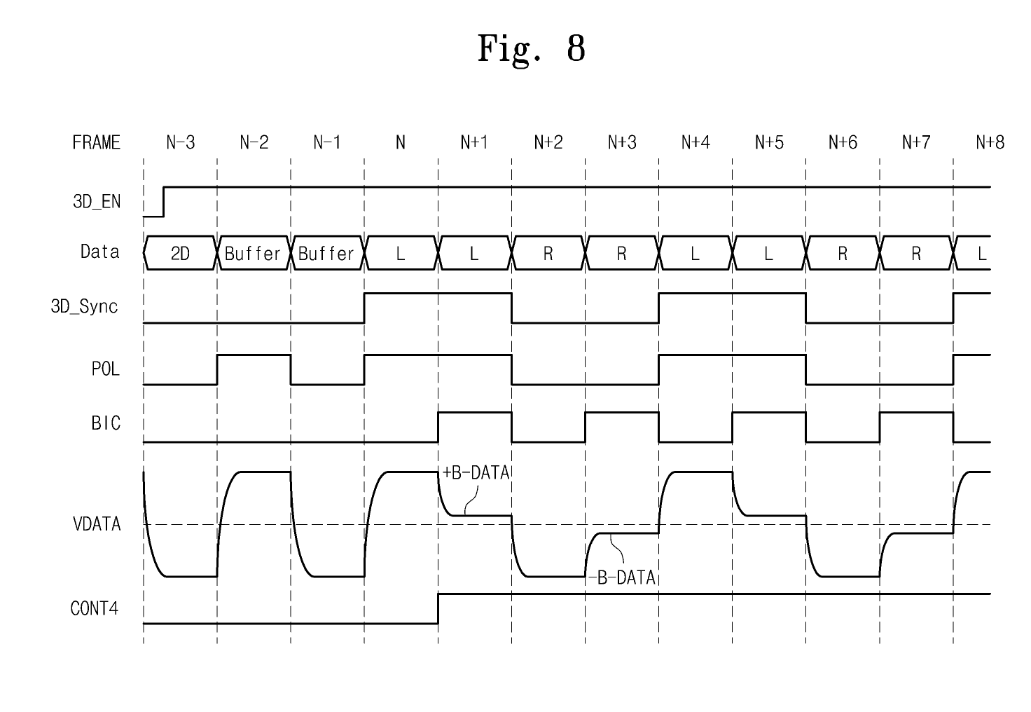

FIG. 8 is a waveform diagram illustrating a driving operation of a display apparatus with reference to FIGS. 1 and 7.

Referring to FIG. 8, the frame rate converter 180 receives the 2-D image signal DATA from the repeater 170 and converts the 2-D image signal DATA to the 3-D image signal LLRR in response to the 3-D enable signal 3D_EN. In particular, the frame rate converter 180 separates the 2-D image signal DATA into the left-eye image frame L and the right-eye image frame R and inserts the intermediate image frame between the left-eye image frame L and the right-eye image frame R to output the four-times-faster image signal LLRR as the 3-D image signal.

As shown in FIG. 8, when the 3-D enable signal 3D_EN is transited to a logic high level during a (N−3)-th frame period, the frame rate converter 180 uses a (N−2)-th frame period and a (N−1)-th frame period as a buffer period in order to separate the 2-D image signal DATA to the 3-D image signal LLRR and outputs the 3-D image signal LLRR from an N-th frame period. In the present exemplary embodiment, the left-eye image frame L is output during the N-th frame period, the first intermediate image frame L having the same value as the left-eye image frame L is output during the (N+1)-th frame period, the right-eye image frame R is output during the (N+2)-th frame period, and the second intermediate image frame R having the same value as the right-eye image frame R is output during the (N+3)-th frame period.

The 3-D timing converter 330 provides the inversion control signal PCS to the timing controller 160 in response to the 3-D synchronization signal 3D_sync provided from the video system. As an example, the 3-D synchronization signal 3D_sync may be maintained in a high level during two frame periods corresponding to the left-eye image frame and the first intermediate image frame LL and may be maintained in a low level during two frame periods corresponding to the right-eye image frame R and the second intermediate image frame R.

The timing controller 160 controls the inversion period of the inversion signal POL in response to the inversion control signal PCS. Particularly, the inversion signal POL has the inversion period corresponding to a length corresponding to one frame during the (N−3)-th, (N−2)-th, and (N−1)-th frame periods. Then, when the inversion control signal PCS based on the 3-D synchronization signal 3D_sync is applied to the timing controller 160, the inversion period of the inversion signal POL increases to a length corresponding to two frames. In other words, after the N-th frame period in which the 3-D synchronization signal 3D_sync is generated, the inversion signal POL has the inversion period corresponding to the length of two frames.

In addition, the 3-D timing converter 330 provides the black insertion control signal BIC at a logic high level to the data driver 140 during the (N+1)-th frame period in order to convert the first and second intermediate image frames LR to the black data voltage in response to the 3-D synchronization signal 3D_sync maintained in the logic high level during two frame periods.

The data driver 140 provides the positive-polarity data voltage VDATA corresponding to the left-eye image frame L to the data lines DL1 to DLm during the N-th frame period in response to the left-eye image frame L and the inversion signal POL. Then, the data driver 140 converts the first intermediate image frame to the positive-polarity black data voltage +B-DATA in response to the first and second control signals CT1 and CT2 based on the black insertion control signal BIC and the inversion signal POL and provides the positive-polarity black data voltage +B-DATA to the data lines DL1 to DLm during the (N+1)-th frame period.

In addition, the data driver 140 provides the negative-polarity data voltage VDATA corresponding to the right-eye image frame R to the data lines DL1 to DLm during the (N+2)-th frame period in response to the right-eye image frame R and the inversion signal POL. Then, the data driver 140 converts the second intermediate image frame to the negative-polarity black data voltage −B-DATA in response to the first and second control signals CT1 and CT2 based on the black insertion control signal BIC and the inversion signal POL and provides the negative-polarity black data voltage −B-DATA to the data lines DL1 to DLm during the (N+3)-th frame period.

As described above, the display apparatus inserts the intermediate image frame between the left-eye image frame and the right-eye image frame and converts the intermediate image frame to the black data voltage to display the 3-D image, thereby preventing the left-eye image from being mixed with the right-eye image.

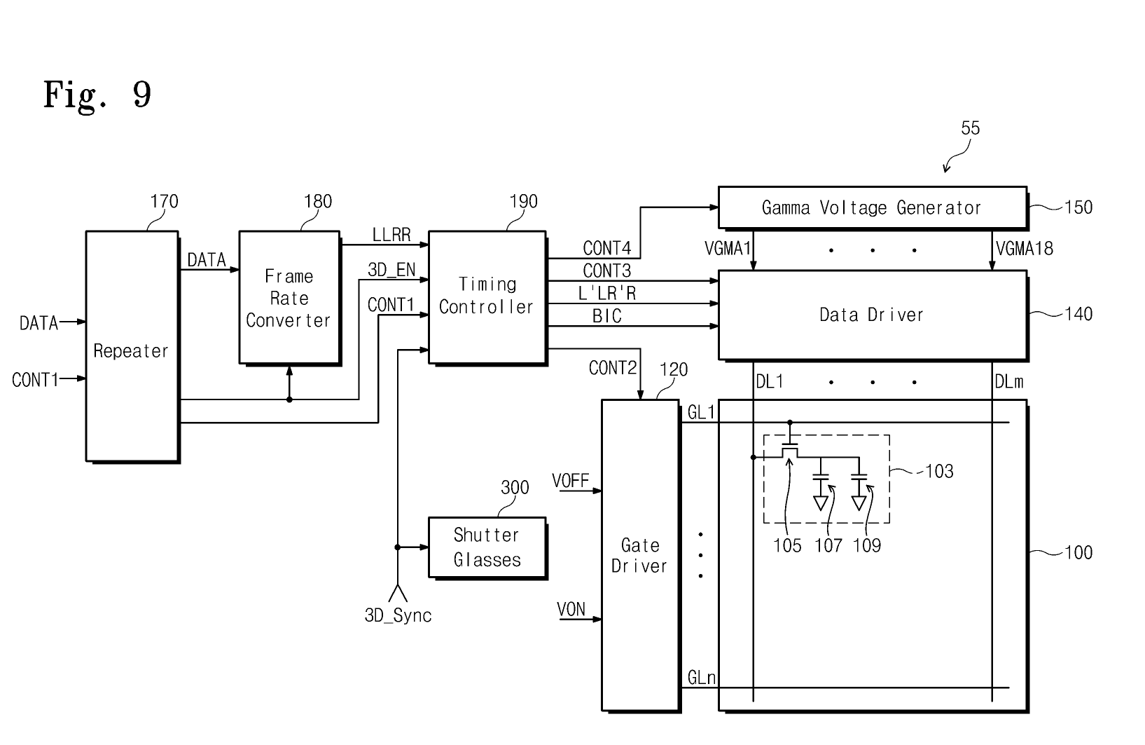

FIG. 9 is a block diagram showing a display apparatus according to another exemplary embodiment of the present invention. In FIG. 9, the same reference numerals denote the same elements in FIG. 1, and thus detailed descriptions of the same elements will be omitted.

Referring to FIG. 9, a display apparatus 55 includes a display panel 100 displaying an image, a gate driver 120 driving the display panel 100 together with a data driver 140, a gamma voltage generator 150 connected to the data driver 140, and a timing controller 190 controlling the gate driver 120 and the data driver 140. The display apparatus 55 may further include a repeater 170 and a frame rate converter 180.

The display apparatus 55 shown in FIG. 9 has the similar structure and function as those of the display apparatus 50 shown in FIG. 1 except for the structure that the 3-D timing converter 330 and the frame memory 310 are built in the timing controller 190.

The timing controller 190 receives the four-times-faster image signal LLRR from the frame rate converter 180 and a control signal CONT1 from the repeater 170. The timing controller 190 compensates for the four-times-faster image signal LLRR by using a data compensation method compensating for charge rate of each pixel and outputs a four-times-faster compensation image signal L′LR′R. In detail, the timing controller 190 compensates for the left-eye image frame L to generate a left-eye compensation frame L′ and compensates for the right-eye image frame R to generate a right-eye compensation frame R′. In addition, the timing controller 190 outputs the first and second intermediate image frames L and R without applying the data compensation method to the first and second intermediate image frames L and R.

The timing controller 190 may include a frame memory installed therein in order to sequentially store frames of the four-times-faster image signal LLRR for the compensation of the data. In addition, the timing controller 190 receives the 3-D synchronization signal 3D_sync from the video system and provides the black insertion control signal BIC to the data driver 140 in response to the 3-D synchronization signal 3D_sync.

As described above, since the functions of the 3-D timing converter 330 and the frame memory 310 are performed by the timing controller 190, the number of the parts included in the display apparatus 55 may be reduced.

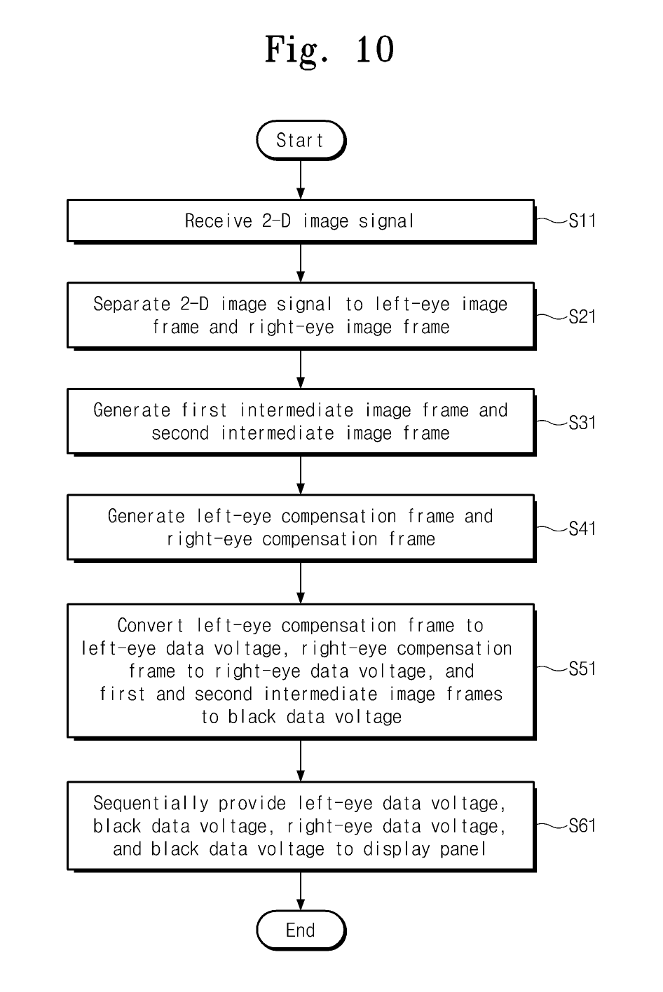

FIG. 10 is a flow chart illustrating a method of displaying the 3-D image on a display apparatus of FIG. 1.

Referring to FIGS. 1 and 10, the frame rate converter 180 receives the 2-D image signal DATA from the video system (S11).

The frame rate converter 180 separates the 2-D image signal DATA to the left-eye image frame L and the right-eye image frame R using the data divider 181 shown in FIG. 2 (S21).

The intermediate image inserter 183 shown in FIG. 2 receives the left-eye image frame L and the right-eye image frame R and generates the first intermediate image frame L following the left-eye image frame L and the second intermediate image frame R following the right-eye image frame R (S31). The first intermediate image frame L may have the same value as the left-eye image frame L and the second intermediate image frame R may have the same value as the right-eye image frame R.

The frame rate converter 180 provides the four-times-faster image signal LLRR including the left-eye image frame L, the first intermediate image frame L, the right-eye image frame R, and the second intermediate image frame R to the timing controller 160.

The timing controller 160 compensates for the four-times-faster image signal LLRR by using the data compensation method compensating for charge rate of each pixel and outputs the four-times-faster compensation image signal L′LR′R. In detail, the timing controller 160 compensates for the left-eye image frame L to generate the left-eye compensation frame L′ and compensates for the right-eye image frame R to generate the right-eye compensation frame R′ (S41). In addition, the timing controller 160 outputs the first and second intermediate image frames L and R without applying the data compensation method to the first and second intermediate image frames L and R. Thus, the timing controller 160 may provide the four-times-faster compensation image signal L′LR′R to the data driver 140.

The data driver 140 converts the left-eye compensation frame L to a left-eye data voltage and the right-eye compensation frame R to a right-eye data voltage. In addition, the data driver 140 converts the first intermediate image frame L and the second intermediate image frame R to the predetermined black data voltage in response to the black image control signal BIC provided from the 3-D timing converter 330 (S51).

The data driver 140 sequentially provides the left-eye data voltage, the black data voltage, the right-eye data voltage, and the black data voltage to the display panel 100 (S61). Accordingly, the display panel 100 sequentially receives the left-eye data voltage, the black data voltage, the right-eye data voltage, and the black data voltage to display the 3-D image.

As described above, according to the displaying method of the 3-D image, the first and second intermediate image frames are inserted to follow the left-eye image frame and the right-eye image frame, respectively, and the first and second intermediate image frames are converted to the black data voltage, to thereby prevent the left-eye image from being mixed with the right-eye image.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel that displays an image;
a frame rate converter that separates an image signal from an exterior to a first image frame for a left-eye and a second image frame for a right-eye and generates a first intermediate image frame following the first image frame and a second intermediate image frame following the second image frame to convert the image signal to a four-times-faster image signal;
a timing controller that compensates for the first and second image frames to generate first and second compensation frames, respectively, and sequentially outputs the first compensation frame, the first intermediate image frame, the second compensation frame, and the second intermediate image frame; and
a data driver that converts the first and second compensation frames from the timing controller to a left-eye data voltage and a right-eye data voltage, respectively, and converts the first and second intermediate image frames to a black data voltage corresponding to a predetermined black gray scale in response to a black insertion control signal to provide the black data voltage to the display panel.

2. The display apparatus of claim 1, wherein the first intermediate image frame has a value same as the first image frame and the second intermediate image frame has a value same as the second image frame.

3. The display apparatus of claim 1, further comprising a 3-dimensional timing converter that generates the black insertion control signal in response to a 3-dimensional synchronization signal and applies the black insertion control signal to the data driver.

4. The display apparatus of claim 3, further comprising a frame memory that sequentially stores frames included in the four-times-faster image signal.

5. The display apparatus of claim 4, wherein the timing controller compensates for a present image frame based on a previous image frame that is previously stored in the frame memory.

6. The display apparatus of claim 3, wherein the data driver controls a polarity of the left-eye data voltage and the right-eye data voltage in response to an inversion signal, and the left-eye data voltage and the right-eye data voltage have different polarities from each other with respect to a predetermined reference voltage.

7. The display apparatus of claim 6, wherein the black data voltage has a voltage level same as the reference voltage.

8. The display apparatus of claim 6, wherein the black data voltage comprises a first black data voltage and a second black data voltage, the first and second black data voltages have different polarities from each other with respect to the reference voltage, and the data driver selectively outputs either the first black data voltage or the second black data voltage according to the polarity of the left-eye and right-eye data voltages in response to the inversion signal and the black insertion control signal.

9. The display apparatus of claim 6, wherein the 3-dimensional timing converter generates an inversion control signal to control an inversion of the polarity of the left-eye data voltage and the right-eye data voltage in response to the 3-dimensional synchronization signal and provides the inversion control signal to the timing controller, and the timing controller changes an inversion period of the inversion signal in response to the inversion control signal and provides the inversion signal to the data driver.

10. The display apparatus of claim 9, wherein a state of the inversion signal is inverted at every two frame.

11. The display apparatus of claim 1, wherein the timing controller comprises:
a 3-dimensional timing converter that generates the black insertion control signal in response to a 3-dimension synchronization signal and applies the black insertion control signal to the data driver; and
a frame memory that sequentially stores frames included in the four-times-faster image signal.

12. The display apparatus of claim 11, wherein the data driver controls a polarity of the left-eye data voltage and the right-eye data voltage in response to an inversion signal, and the left-eye data voltage and the right-eye data voltage have different polarities from each other with respect to a predetermined reference voltage.

13. The display apparatus of claim 12, wherein the black data voltage has a voltage level as the reference voltage.

14. The display apparatus of claim 1, further comprising a gamma voltage generator to provide a gamma reference voltage to the data driver, and wherein the data driver converts the left-eye compensation frame and the right-eye compensation frame to the left-eye data voltage and the right-eye data voltage, respectively, in response to the gamma reference voltage.

15. The display apparatus of claim 1, wherein the frame rate converter has a driving frequency of about 240 Hz.

16. A method of driving a display apparatus, comprising:
separating an image signal to a first image frame for a left-eye and a second image frame for a right-eye;
generating a first intermediate image frame following the first image frame and a second intermediate image frame following the second image frame;
compensating for the first and second image frames to generate a first compensation frame and a second compensation frame;
converting the first and second compensation frames to a left-eye data voltage and a right-eye data voltage, respectively, and converting the first and second intermediate image frames to a black data voltage corresponding to a predetermined black gray scale in response to a black insertion control signal; and
displaying an image in order of the left-eye data voltage, the black data voltage, the right-eye data voltage, and the black data voltage.

17. The method of claim 16, wherein the left-eye data voltage and the right-eye data voltage have different polarities from each other with respect to a predetermined reference voltage.

18. The method of claim 17, wherein the black data voltage has a voltage level as the reference voltage.

19. The method of claim 17, wherein the black data voltage comprises a first black data voltage and a second black data voltage, the first and second black data voltages have different polarities from each other with respect to the reference voltage, and either the first black data voltage or the second black data voltage is selected according to the polarity of the left-eye and right-eye data voltages.

20. A method of driving a display apparatus, comprising:
separating an image signal to a first image frame for a left-eye and a second image frame for a right-eye;
generating a first intermediate image frame following the first image frame and a second intermediate image frame following the second image frame;
converting the first image frame to a left-eye data voltage and the second image frame to a right-eye data voltage;
inserting a black data voltage corresponding to a predetermined black gray scale between the left-eye data voltage and the right-eye data voltage in response to a black insertion control signal; and
consecutively receiving the left-eye data voltage, the black data voltage, and the right-eye data voltage to display an image.

21. The method of claim 20, wherein the left-eye data voltage and the right-eye data voltage have different polarities from each other with respect to a predetermined reference voltage.

22. The method of claim 20, wherein the black data voltage has a voltage level as the reference voltage.

23. The method of claim 20, wherein the black data voltage comprises a first black data voltage and a second black data voltage, the first and second black data voltages have different polarities from each other with respect to the reference voltage, and either the first black data voltage or the second black data voltage is selected according to the polarity of the left-eye and right-eye data voltages.
